(19) United States
(12) Patent Application Publication
(10) Pub. No.: US 2010/0008063 A1
(43) Pub. Date: Jan. 14, 2010

(54) Light diffusion plate and backlight module using the same

(75) Inventor: Shao-Han Chang, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: Hon Hai Precision Industry Co., LTD.

(21) Appl. No.: 12/319,041

(22) Filed: Dec. 31, 2008

(30) Foreign Application Priority Data
Jul. 11, 2008 (CN) 200810302703.4

(51) Int. Cl. G02F 1/13357; G02B 5/02

(52) U.S. Cl. 362/97.1; 359/599

(57) ABSTRACT

A light diffusion plate includes a transparent main body having a plurality of diffusion particles distributed in the transparent main body. The main body includes a first surface, a second surface opposite to the first surface, a plurality of elongated arc-shaped protrusions formed on the first surface, and a plurality of elongated arc-shaped grooves defined in the second surface, an extending direction of the elongated arc-shaped grooves intersects with an extending direction of the elongated arc-shaped protrusions. A backlight module using the light diffusion plate is also provided.

### CROSS REFERENCE STATEMENT

This application is related to co-pending U.S. patent applications, which are applications Ser. No. 12/197,319, Ser. No. [to be determined], with Attorney Docket Nos. US21025, US21581, US21604, and all entitled “OPTICAL PLATE AND BACKLIGHT MODULE USING THE SAME,” applications Ser. No. [to be determined], with Attorney Docket No. US23066, entitled “LIGHTING DEVICE”. In the co-pending applications, the inventor is Shao-Han Chang. The co-pending applications have the same assignee as the present application. The disclosure of the above identified applications is incorporated herein by reference.

### BACKGROUND

1. Field of the Invention

The present disclosure relates to a light diffusion plate for use in a backlight module.

2. Discussion of the Related Art

Referring to FIG. 6, a typical direct type backlight module 100 includes a frame 11, a plurality of light sources 12, a light diffusion plate 13, and a prism sheet 10. The light sources 12 are positioned in an inner side of the frame 11. The light diffusion plate 13 and the prism sheet 10 are positioned on the light sources 12 above a top of the frame 11. The light diffusion plate 13 includes a plurality of diffusing particles (not shown) to diffuse light. The prism sheet 10 includes a transparent substrate 101 and a prism layer 103 formed on a surface of the transparent substrate 101. A plurality of elongated V-shaped ridges 105 is formed on the prism layer 103.

In use, light emitted from the light sources 12 enters the diffusion plate 13 and becomes scattered. The scattered light leaves the diffusion plate 13, travels through the prism sheet 10, and is refracted out at the elongated V-shaped ridges 105. The refracted light leaving the prism sheet 10 is concentrated at the prism layer 103 and increases the brightness of the prism sheet 10. The refracted light propagates into a liquid crystal display panel (not shown) positioned above the prism sheet 10.

However, although light from the light sources 12 enters the diffusion plate 13 and becomes scattered, the light leaves the prism sheet 10, and forms strong light spots. In order to reduce or eliminate the strong light spots, the backlight module 100 may include an upper light diffusion film 14 disposed on the typical prism sheet 10.

However, although the upper light diffusion film 14 and the typical prism sheet 10 are contacting each other, a plurality of air pockets exist around the boundaries of the light diffusion film 14 and the prism sheet 10. When light passes through the air pockets, some of the light undergoes total reflection along one or more corresponding boundaries. In addition, the upper light diffusion film 14 may absorb a certain amount of the light from the prism sheet 10. As a result, a brightness of light illumination of the backlight module 100 is reduced.

What is needed, therefore, is a new light diffusion plate and a backlight module using the light diffusion plate that can overcome the above-mentioned shortcomings.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout several views, and all the views are schematic.

FIG. 1 is a cross-sectional view of one embodiment of a backlight module, the backlight module including a first embodiment of the light diffusion plate.

FIG. 2 is an isometric view of the light diffusion plate in FIG. 1.

FIG. 3 is a photo showing an illumination distribution test of the light diffusion plate in FIG. 2 positioned above an LED.

FIG. 4 is a plan view of a second embodiment of a light diffusion plate.

FIG. 5 is a side plan view of a third embodiment of a light diffusion plate.

FIG. 6 is a cross-sectional view of a typical backlight module.

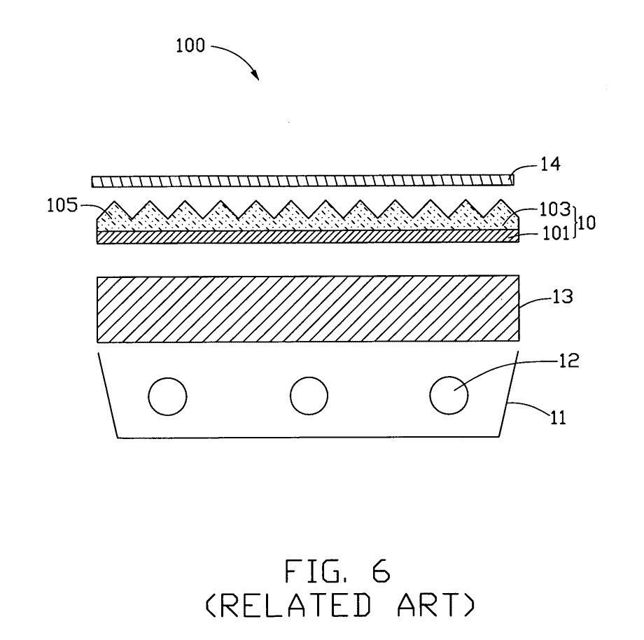

### DETAILED DESCRIPTION OF THE EMBODIMENTS

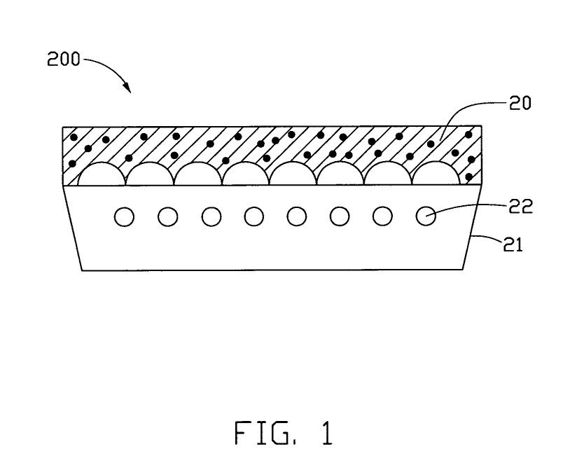

Referring to FIG. 1, a backlight module 200 includes a light diffusion plate 20, a plurality of light sources 22, and a frame 21. The light sources 22 are positioned in an inner side of the frame 21. The light sources 22 may be a plurality of light emitting diodes or cold cathode fluorescent lamps. The light diffusion plate 20 is positioned on the light sources 22 above a top of the frame 21.

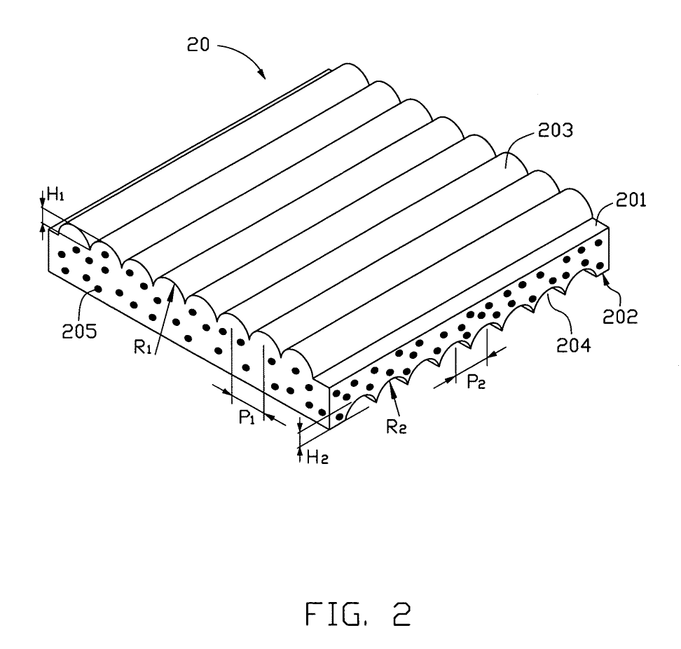

Referring to FIG. 2, the light diffusion plate 20 includes a transparent main body, and a plurality of diffusion particles 205 dispersed in the transparent main body. A shape of the main body may be a square cube. The main body includes a first surface 201 and a second surface 202 opposite to the first surface 201. A plurality of elongated substantially parallel arc-shaped protrusions 203 are formed on the first surface 201. The second surface 202 defines a plurality of elongated substantially parallel arc-shaped grooves 204. An extending direction of the elongated arc-shaped protrusions 203 intersects with an extending direction of the elongated arc-shaped grooves 204. In the illustrated embodiment, the extending direction of the elongated arc-shaped protrusions 203 is substantially perpendicular to those of the elongated arc-shaped grooves 204.

A cross-section of each arc-shaped protrusion 203 taken along a plane perpendicular to the extending direction of the elongated arc-shaped protrusions 203 is substantially semicircular. The elongated arc-shaped protrusions 203 are distributed side by side in the first surface 201. The radius R₁ defined by each elongated arc-shaped protrusion 203 is about 0.01 millimeter (mm) to about 3 mm. The pitch P₁ of adjacent elongated arc-shaped protrusions 203, measured between two corresponding points on a cross-section line, is about 0.025 mm to about 1.5 mm. The height H₁ of each elongated arc-shaped protrusion 203 is about 0.01 mm to about 3 mm. [0018] A cross-section of each arc-shaped groove 204 taken along a plane perpendicular to an extending direction of the elongated arc-shaped grooves 204 is substantially semicircular. The elongated arc-shaped grooves 204 are distributed side by side to each other in the second surface 202. The radius R₂ defined by each elongated arc-shaped groove 204 is about 0.01 mm to about 3 mm. The pitch P₂ between adjacent elongated arc-shaped grooves 204 is about 0.025 mm to about 1.5 mm. The depth H₂ of each elongated arc-shaped groove 204 is about 0.01 mm to about 3 mm.

A thickness of the light diffusion plate 20 is about 0.5 mm to about 3 mm. The light diffusion plate 20 may be integrally formed by an injection molding method. The main body of the light diffusion plate 20 may be made of materials such as polycarbonate, polymethyl methacrylate, polystyrene, copolymer of methylmethacrylate and styrene, and any suitable combination thereof. The diffusion particles 205 may be silicon dioxide particles, titanium dioxide particles, acrylate copolymer particles, or any combination of those.

In the illustrated embodiment, the second surface 202 of the light diffusion plate 20 is adjacent to the light sources 22 and the first surface 201 is faces away from the light sources 22. Light enters the light diffusion plate 20 via the second surface 202. Since the inner surfaces of the elongated arc-shaped grooves 204 are curved and the outer surfaces of the elongated arc-shaped protrusions 203 are also curved, incident light that may have been internally reflected on a flat surface, are refracted, reflected, and diffracted. As a result, light outputted from the first surface 201 is more uniform. Since, light spots caused by the light sources seldom occur, an extra upper light diffusion film between the light diffusion plate 20 and the liquid crystal display panel is unnecessary. Thus, the efficiency of light utilization is enhanced.

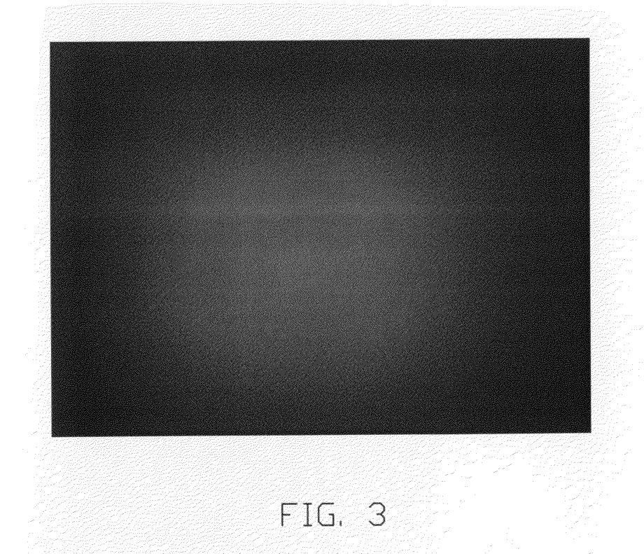

Referring to FIG. 3, an illumination distribution of the light diffusion plate 20 positioned above an LED is shown. The test result shows light emitting from the light diffusion plate 20 forms a relatively uniform surface light source. Therefore, when the light diffusion plate 20 is employed in the backlight module 200, light spots of the light sources seldom occur, more uniform light is achieved, and an upper light diffusion film between the light diffusion plate 20 and the liquid crystal display panel is unnecessary. Thus, the efficiency of light utilization is enhanced.

In addition, since the light diffusion plate 20 is integrally formed by the injection molding method, the light diffusion plate 20 has a relatively high reliability. Moreover, the extending direction of the elongated arc-shaped protrusions 203 may be substantially perpendicular to those of the elongated arc-shaped grooves 204, thus decreasing occurrences of interference lines on the first surface 201.

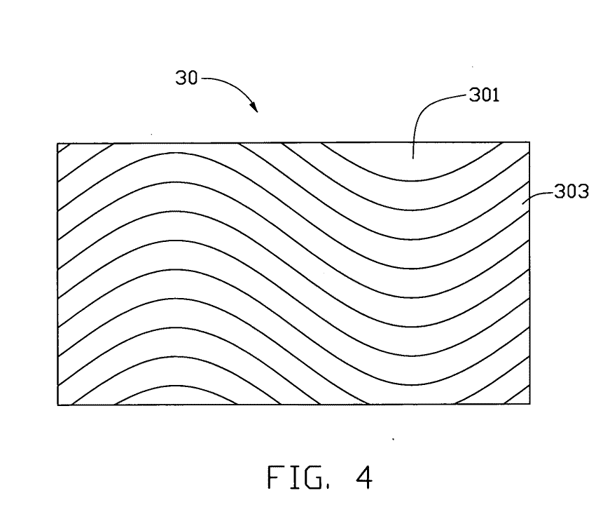

Referring to FIG. 4, a second embodiment of a light diffusion plate 30 is similar to the first embodiment of the light diffusion plate 20, except that the light diffusion plate 30 includes a plurality of elongated arc-shaped protrusions 303 extending along imaginary curves on a first surface 301. In the illustrated embodiment, each of the elongated arc-shaped protrusions 303 extends along a predetermined S-shaped curve. Since the arrangement of the curved, elongated arc-shaped protrusions 303 may be aligned obliquely relative to the LCD pixels in the X-direction or the Y-direction, moire interference caused by the light diffusion plate 30 and the pixel pitch of a LCD panel are minimized or eliminated. In another embodiment, a plurality of elongated arc-shaped grooves may also extend along curves on a second surface.

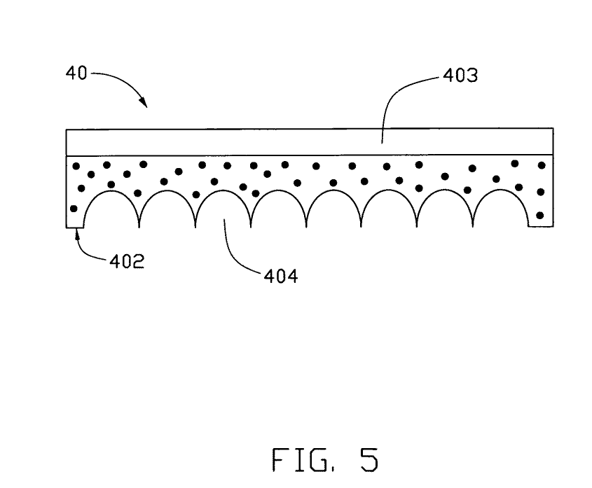

Referring to FIG. 5, a third embodiment of a light diffusion plate 40 is similar to the first embodiment of the light diffusion plate 20, except that the light diffusion plate 40 includes a plurality of elongated arc-shaped grooves 404 formed in a second surface 402. The cross-section of each elongated arc-shaped groove 404 taken along a plane perpendicular to the extending direction of the elongated arc-shaped grooves 404 is substantially semi-elliptical. In other embodiments, the cross-section of each elongated arc-shaped groove 404 may have other shapes, such as parabolic curves, sinusoidal curves, and so on.

Finally, while various embodiments have been described and illustrated, the present disclosure is not to be construed as being limited thereto. Various modifications can be made to the embodiments by those skilled in the art without departing from the true spirit and scope of the present disclosure as defined by the appended claims.

What is claimed is:

1. A light diffusion plate, comprising:
a main body comprising:
a first surface,
a second surface opposite to the first surface,
a plurality of elongated arc-shaped protrusions formed on the first surface, and
a plurality of elongated arc-shaped grooves defined in the second surface, wherein an extending direction of the elongated arc-shaped grooves intersects with an extending direction of the elongated arc-shaped protrusions; and
a plurality of diffusion particles dispersed in the main body.

2. The light diffusion plate of claim 1, wherein the extending direction of the elongated arc-shaped protrusions is substantially perpendicular to the extending direction of the elongated arc-shaped grooves.

3. The light diffusion plate of claim 1, wherein the plurality of elongated arc-shaped protrusions is distributed side by side in the first surface.

4. The light diffusion plate of claim 1, wherein a cross-section of each elongated arc-shaped protrusion taken along a plane perpendicular to the extending direction of the elongated arc-shaped protrusion is substantially semicircular.

5. The light diffusion plate of claim 4, wherein a radius defined by each elongated arc-shaped protrusion is about 0.01 millimeters to about 3 millimeters.

6. The light diffusion plate of claim 1, wherein a pitch between adjacent elongated arc-shaped protrusions is about 0.025 millimeters to about 1.5 millimeters.

7. The light diffusion plate of claim 1, wherein a height of each elongated arc-shaped protrusion is about 0.01 millimeters to about 3 millimeters.

8. The light diffusion plate of claim 1, wherein a thickness of the light diffusion plate is about 0.5 millimeters to about 3 millimeters.

9. The light diffusion plate of claim 1, wherein the plurality of elongated arc-shaped grooves is distributed side by side in the second surface.

10. The light diffusion plate of claim 1, wherein a cross-section of each elongated arc-shaped groove taken along a plane perpendicular to the extending direction of the elongated arc-shaped groove is substantially semicircular.

11. The light diffusion plate of claim 10, wherein a radius defined by each elongated arc-shaped groove is about 0.01 millimeters to about 3 millimeters.

12. The light diffusion plate of claim 1, wherein a pitch between adjacent elongated arc-shaped grooves is about 0.025 millimeters to about 1.5 millimeters.

13. The light diffusion plate of claim 1, wherein a depth of each elongated arc-shaped groove is about 0.01 millimeters to about 3 millimeters.

14. The light diffusion plate of claim 1, wherein a material of the light diffusion plate is selected from the group consisting of polycarbonate, polymethyl methacrylate, polystyrene, and copolymer of methylmethacrylate and styrene.

15. The light diffusion plate of claim 1, wherein the plurality of elongated arc-shaped protrusions is substantially parallel to each other; the plurality of elongated arc-shaped grooves is substantially parallel to each other.

16. The light diffusion plate of claim 1, wherein the diffusion particles are selected from the group consisting of silicon dioxide particles, titanium dioxide particles, acrylate copolymer particles, and any combination of those.

17. The light diffusion plate of claim 1, wherein the plurality of elongated arc-shaped protrusions extend along curves on the first surface; the plurality of elongated arc-shaped grooves extend along curves on the second surface.

18. The light diffusion plate of claim 1, wherein a cross-section of each elongated arc-shaped groove taken along a plane perpendicular to the extending direction of the elongated arc-shaped grooves is substantially semi-elliptical.

19. A backlight module, comprising:
a frame;
a plurality of light sources positioned in an inner surface of the frame;
a light diffusion plate positioned on a top of the frame above the light sources, the light diffusion plate comprising a main body, and a plurality of diffusion particles dispersed in the main body, the main body comprising a first surface, a second surface opposite to the first surface, a plurality of elongated arc-shaped protrusions formed on the first surface, and a plurality of elongated arc-shaped grooves defined in the second surface, wherein an extending direction of the elongated arc-shaped grooves intersects with an extending direction of the elongated arc-shaped protrusions.

20. The backlight module of claim 19, wherein the plurality of light sources are light emitting diodes or cold cathode fluorescent lamps.
